(19) United States
(12) Patent Application Publication
(10) Pub. No.: US 2016/0292845 A1
(43) Pub. Date: Oct. 6, 2016

(54) DETERMINING CONTACT EDGE ROUGHNESS OF A CONTACT HOLE ETCHED IN A WAFER

(71) Applicant: MACRONIX INTERNATIONAL CO., LTD., Hsin-Chu (TW)

(72) Inventor: CHING-REN CHENG, Taipei City (TW)

(21) Appl. No.: 14/674,199

(22) Filed: Mar. 31, 2015

(51) Int. Cl. G06T 7/00; G06T 7/60; G06T 7/40

(52) U.S. Cl. CPC G06T 7/0006; G06T 7/0085; G06T 7/40; G06T 7/60; G06T 2207/10061; G06T 2207/30148

(57) ABSTRACT

Embodiments of the present invention provide methods, systems, apparatuses, and computer program products for determining the contact edge roughness of a contact hole etched in a wafer. One embodiment provides a method comprising acquiring image data corresponding to the hole; based at least in part on the image data, determining a hole profile; determining an ideal shape for the hole based at least in part on the hole profile; and determining the contact edge roughness based at least in part on the hole profile and ideal shape. The hole profile may be configured to describe a distance from a reference point of the contact hole to an edge of the contact hole for each of a predetermined set of angles and the ideal shape may be described by a distance from a reference point of the ideal shape to an edge of the ideal shape for each predetermined angle.

### BACKGROUND

Modern electronic devices are made possible by integrated circuits. An integrated circuit is an electronic circuit formed on a small piece of semiconducting material (e.g., silicon), often referred to as a wafer. To fabricate an integrated circuit on a wafer, contact holes are etched into the wafer. The contact holes may then be filled with conductive or semi-conductive material to electrically connect various components of the integrated circuit.

In general, the contact holes etched in wafers are intended to be circular or elliptical. However, in reality the contact holes are often not circular or elliptical. Moreover, the edges of the contact holes tend to not be smooth. The roughness of the edges of the contact holes may affect the source/drain contact resistance and the saturation current of the resulting integrated circuit and may cause time-dependent-dielectric-breakdown of the circuit. However, current methods of monitoring and/or measuring the roughness of the edge of a contact hole require the assumption that the contact hole is circular or elliptical. This assumption leads to a biased determination of the roughness of contact hole edges.

Thus, a need exists in the art for improved methods, systems, apparatuses, and computer program products for monitoring and/or measuring the roughness of the edge of a contact hole.

### BRIEF SUMMARY

Exemplary embodiments provide methods, apparatus, systems, and computer program products for determining the contact edge roughness of the edge of a contact hole etched in a wafer. In one aspect of the present invention, a method is provided. In one embodiment, the method comprises acquiring image data corresponding to the hole and, based at least in part on the image data, determining a hole profile. The hole profile may be configured to describe a distance from a reference point of the hole (e.g., the center of the hole) to an edge of the hole for each angle of a predetermined set of angles. The method may further comprise determining an ideal shape for the contact hole based at least in part on the hole profile. The ideal shape for the hole may be described by a distance from a reference point of the ideal shape (e.g., the center of the ideal shape) to an edge of the ideal shape for each angle of the predetermined set of angles. The method may still further comprise determining the contact edge roughness based at least in part on the hole profile and the ideal shape.

In another aspect of the present invention, a system is provided. The system may comprise at least one processor and at least one memory including program code. The at least one memory and the program code may be configured to, with the processor, cause the system to at least acquire image data corresponding to the hole and, based at least in part on the image data, determine a hole profile. The hole profile may be configured to describe a distance from a reference point of the hole (e.g., the center of the hole) to an edge of the hole for each angle of a predetermined set of angles. The at least one memory and the program code portion may be further configured to, with the processor, cause the system to at least determine an ideal shape for the hole based at least in part on the hole profile. The ideal shape for the hole may be described by a distance from a reference point of the ideal shape (e.g., the center of the ideal shape) to an edge of the ideal shape for each angle of the predetermined set of angles. The at least one memory and the program code portion may be still further configured to, with the processor, cause the system to at least determine the contact edge roughness based at least in part on the hole profile and the ideal shape.

In yet another aspect of the present invention, a computer program product is provided. The non-transitory computer program product comprises at least one computer-readable storage medium having computer-readable program code portions embodied therein. The computer-readable portions comprise an executable portion configured to acquire image data corresponding to the hole and an executable portion configured to, based at least in part on the image data, determine a hole profile. The hole profile may be configured to describe a distance from a reference point of the hole (e.g., the center of the hole) to an edge of the hole for each angle of a predetermined set of angles. The computer-readable portions further comprise an executable portion configured to determine an ideal shape for the hole based at least in part on the hole profile. The ideal shape for the contact hole may be described by a distance from a reference point of the ideal shape (e.g., the center of the ideal shape) to an edge of the ideal shape for each angle of the predetermined set of angles. The computer-readable portions still further comprise an executable portion configured to determine the contact edge roughness based at least in part on the hole profile and the ideal shape.

Further details of these and other embodiments and aspects of the invention are described more fully below, with reference to the attached drawing figures.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram of a system that can be used to practice various embodiments of the present invention;

FIG. 2 is a block diagram of a computing system in accordance with certain embodiments of the present invention;

FIG. 3 is a flowchart illustrating operations and processes that can be used to determine the roughness of the edge of a contact hole in accordance with an embodiment of the present invention;

FIGS. 4A, 4B, and 4C provide example images of a contact hole, a thresholded image of a contact hole, and the edge of a contact hole in accordance with an embodiment of the present invention;

FIG. 5A illustrates measuring a contact hole edge, in accordance with an embodiment of the present invention;

FIG. 5B shows an example measured hole profile, in accordance with an embodiment of the present invention; and

FIG. 6 shows an example determined ideal shape of a contact hole overlaid on an example hole profile, in accordance with an embodiment of the present invention.

### DETAILED DESCRIPTION

Various embodiments of the present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

### I. General Overview

In general, embodiments of the present invention relate to measuring and/or determining the contact edge roughness of a contact hole etched in a wafer. In particular, embodiments of the present invention relate to measuring and/or determining the contact edge roughness of a contact hole of arbitrary shape. According to various embodiments, image data corresponding to a contact hole is analyzed to determine a hole profile describing the edge of the contact hole. An ideal shape for the contact hole is determined. The contact edge roughness of the contact hole may then be determined based on the deviation of the edge of the contact hole, as described by the hole profile, from the ideal shape of the contact hole.

### II. Methods, Apparatus, Systems, and Computer Program Products

As should be appreciated, the embodiments may be implemented as methods, apparatus, systems, or computer program products. Accordingly, the embodiments may take the form of an entirely hardware embodiment, an entirely software embodiment, or an embodiment combining software and hardware aspects. Furthermore, the various implementations may take the form of a computer program product on a computer-readable storage medium having computer-readable program instructions (e.g., computer software) embodied in the storage medium. More particularly, implementations of the embodiments may take the form of web-implemented computer software. Any suitable computer-readable storage medium may be utilized including hard disks, CD-ROMs, optical storage devices, or magnetic storage devices.

Various embodiments are described below with reference to block diagrams and flowchart illustrations of methods, apparatus, systems, and computer program products. It should be understood that each block of the block diagrams and flowchart illustrations, respectively, can be implemented by computer program instructions, e.g., as logical steps or operations. These computer program instructions may be loaded onto a general purpose computer, special purpose computer, or other programmable data processing apparatus to produce a machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

In general, the terms computing entity, entity, device, system, and/or similar words used herein interchangeably may refer to, for example, one or more computers, computing entities, computing devices, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

### III. Exemplary System Architecture

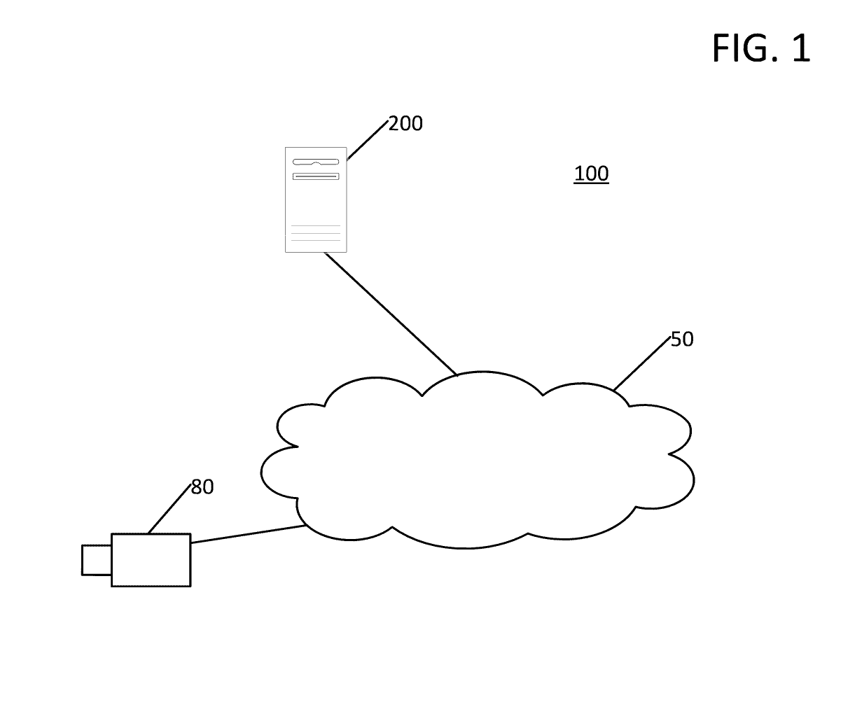

FIG. 1 provides an illustration of a system 100 that can be used in conjunction with various embodiments of the present invention. As shown in FIG. 1, the system 100 may include one or more computing systems 200, one or more image capture devices 80, and one or more networks 50. Each of the components of the system 100 may be in electronic communication (directly or indirectly) with one another, for example, over the same or different wireless or wired networks including, for example, a wired or wireless Personal Area Network (PAN), Local Area Network (LAN), Metropolitan Area Network (MAN), Wide Area Network (WAN), cellular network, and/or the like.

It should be noted that other system architectures are contemplated that may be used to practice various aspects of embodiments of the invention. Thus, the system architecture provided in FIG. 1 is for illustrative purposes only and should not be construed to limit the scope of the invention. Further, while FIG. 1 illustrates certain system entities as separate, standalone entities, the various embodiments are not limited to this particular architecture.

a. Exemplary Computing System

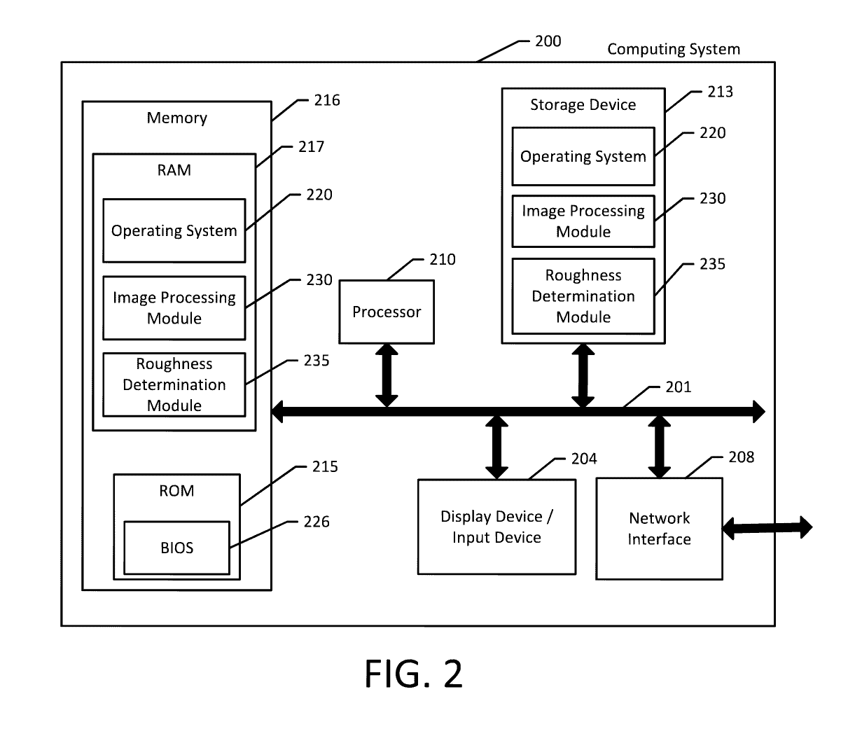

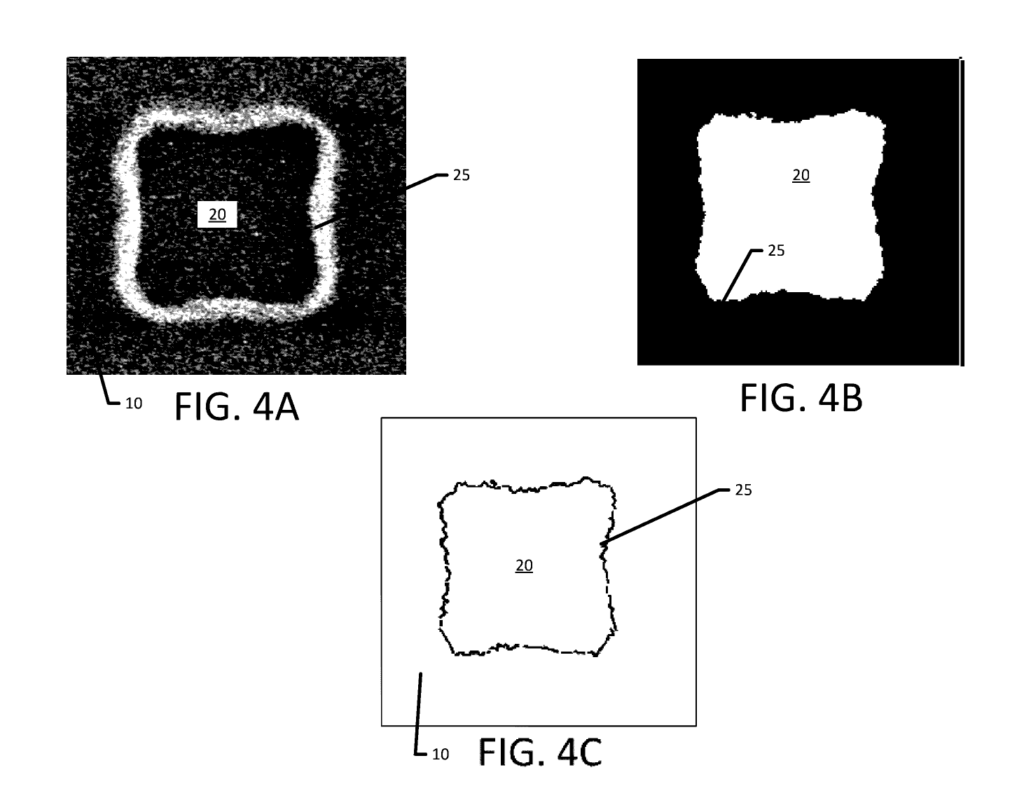

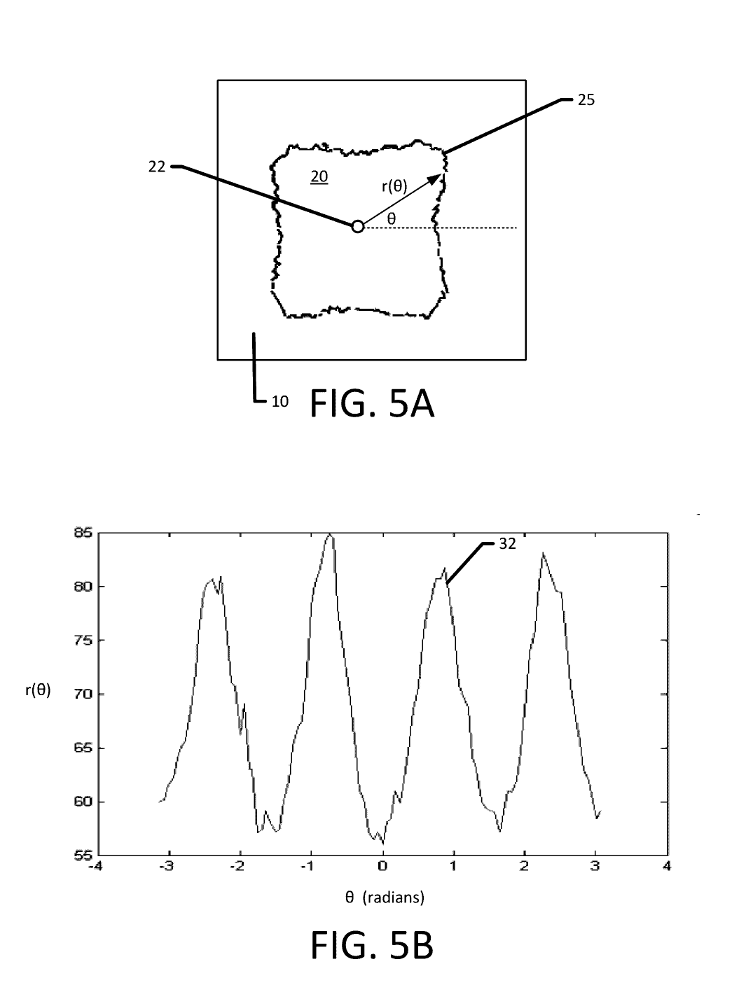

FIG. 2 provides a schematic diagram of an example computing system 200 that may be used in connection with embodiments of the invention. In general, the term “system” may refer to, for example, one or more computers, computing entities, computing devices, desktops, tablets, notebooks, laptops, wearable computing devices, distributed systems, servers or server networks, gateways, switches, processing devices, processing entities, relays, routers, network access points, base stations, the like, and/or any combination of devices or entities adapted to perform the functions, operations, and/or processes described herein. The illustrated computing system 200 includes a processor 210, such as one or more processing elements, which may include complex programmable logic devices (CPLDs), microprocessors, multi-core processors, coprocessing entities, application-specific instruction-set processors (ASIPs), and/or controllers or other processing devices or circuitry. The term circuitry may refer to an entirely hardware embodiment or a combination of hardware and computer program products. Thus, the processor 210 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processor 210 may be configured for a particular use or configured to execute instructions stored in volatile or non-volatile media or otherwise accessible to the processor 210. As such, whether configured by hardware or computer program products, or by a combination thereof, the processor 210 may be configured to perform steps or operations according to embodiments of the present invention, such as the embodiments illustrated in FIGS. 4 and 5, when configured accordingly. The processor 210 is used to execute software instructions for carrying out the defined steps of the method of the various embodiments of the present invention. The processor 210 may communicate using a data bus 201 to convey data and program instructions, typically, between the processor and memory 216.

The computing system 200 further includes memory 216, which may comprise non-volatile media (also referred to as non-volatile storage, memory, memory storage, memory circuitry and/or similar terms used herein interchangeably). In one embodiment, the non-volatile storage or memory may include one or more non-volatile storage or memory media as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. In various embodiments, memory 216 includes both read only memory (ROM) 215 and random access memory (RAM) 217. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include the image processing module 230 and/or the roughness determination module 235. The term database, database instance, database management system, and/or similar terms used herein interchangeably may refer to a structured collection of records or data that is stored in a computer-readable storage medium, such as via a relational database, hierarchical database, and/or network database.

In at least one embodiment, the computing system 200 may further include or be in communication with volatile media (also referred to as volatile storage, memory, memory storage, memory circuitry and/or similar terms used herein interchangeably). In one embodiment, the volatile storage or memory may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processor 210. Thus, the databases, database instances, database management systems, data, applications, programs, program modules, scripts, source code, object code, byte code, compiled code, interpreted code, machine code, executable instructions, and/or the like may be used to control certain aspects of the operation of the computing system 200 with the assistance of the processor 210 and operating system 220, such as the image processing module 230 and/or the roughness determination module 235.

In various embodiments, memory 216 can be considered primary memory such as RAM memory or other forms which retain the contents only during operation, or it may be a non-volatile memory, such as ROM, EPROM, EEPROM, FLASH, or other types of memory that retain the memory contents. In some embodiments, the disk storage may communicate with the processor 210 using an I/O bus instead of a dedicated bus 101. The memory 216 could also be secondary memory, such as disk storage, that stores a relatively large amount of data. The secondary memory may be a floppy disk, hard disk, compact disk, DVD, or any other type of mass storage type known to those skilled in the computer arts. The memory may also comprise any application program interface, system, libraries and any other data by the processor to carry out its functions. ROM 215 is used to store a basic input/output system 226 (BIOS), containing the basic routines that help to transfer information between components of the computing system 200, including the image processing module 230, the roughness determination module 235, and/or the operating system 220.

In addition, the computing system 200 includes at least one storage device 213, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 213 is connected to the system bus 201 by an appropriate interface. It is important to note that the computer-readable media described above could be replaced by any other type of computer-readable media known in the art. Such media include, for example, memory sticks (e.g., USB memories), magnetic cassettes, flash memory cards, and digital video disks.

A number of program modules may be stored by the various storage devices and within RAM 217. Such program modules include the operating system 220, the image processing module 230 and/or the roughness determination module 235. Those skilled in the art will appreciate that other modules may be present in RAM 217 to effectuate the various embodiments of the present invention. Furthermore, rather than program modules, the computing module 230 and/or the parking reservation module 235 may comprise stand-alone computers connectively coupled to the computing system 200.

Also located within the computing system 200 is a network interface 208, for interfacing and communicating with other elements of a computer network, such as by communicating data, content, information, and/or similar terms used herein interchangeably that can be transmitted, received, operated on, processed, displayed, stored, and/or the like. For instance, the computing system 200 may be in communication with one or more driver computing devices 100 and/or the parking reservation system 300. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing system 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Various information may be input by a user to the computing system 200 via the network interface 208 and/or input/output device 204. This input information may include information related to items to be delivered, information related to parking reservations that have been or may be requested or other information. This input information may vary, however, depending on the configuration and informational requirements of the computing system 200.

As mentioned above, the computing system 200 also includes an input/output device 204 for receiving and displaying data. The computing system 200 may include or be in communication with one or more input elements, such as a keyboard input, a mouse input, a touch screen/display input, audio input, pointing device input, joystick input, keypad input, and/or the like, as indicated by input/output device 204. The computing system 200 may also include or be in communication with one or more output elements, as indicated by input/output device 204, such as audio output, video output, screen/display output, motion output, movement output, and/or the like.

The computing system 200 is configured to analyze image data corresponding to a contact hole and determine the contact edge roughness. The computing system 200 may further be configured to receive image data corresponding to a contact hole from an image capture device 80.

Those skilled in the art will recognize that many other alternatives and architectures are possible and can be used to practice various embodiments of the invention. The embodiment illustrated in FIG. 2 can be modified in different ways or incorporated within a network and be within the scope of the invention. For example, one or more components of the computing system 200 may be located remotely from other computing system 200 components, such as in a distributed system. Furthermore, one or more of the components may be combined and additional components performing functions described herein may be included in the computing system 200. Thus, the computing system 200 can be adapted to accommodate a variety of needs and circumstances.

b. Exemplary Image Capture Device

Various embodiments comprise an image capture device 80. The image capture device 80 may be configured to capture image data corresponding to a contact hole and provide the image data to the computing system 200. In one embodiment, the image capture device 80 may include one or more components that are functionally similar to those of the computing system 200. For example, in one embodiment, the image capture device 80 may include one or more processing elements, one or more display device/input devices, volatile and non-volatile storage or memory, and/or one or more communications interfaces. Additionally, the image capture device 80 may include components configured to capture image data corresponding to a contact hole, and/or the like. In one embodiment, the image capture device 80 is a scanning electron microscope.

### IV. Exemplary System Operation

As noted above, various embodiments of the present invention relate to determining the contact edge roughness of a contact hole etched in a wafer. In particular, embodiments are directed to measuring and/or determining the contact edge roughness of contact holes having arbitrary shapes. An example embodiment comprises analyzing image data corresponding to a contact hole to determine a hole profile describing the edge of the contact hole, determining an ideal shape of the contact hole, and determining and/or calculating the contact edge roughness based on the deviation of the hole profile from the ideal shape. In particular, the hole profile may describe the distance from the center or other reference point of the contact hole to a point on the edge of the contact hole. Additionally, the ideal shape is configured to describe the shape of the arbitrarily shaped contact hole if the contact hole edge was smooth. For example, the ideal shape may define a distance from the center or other reference point of the ideal shape to a point on the edge of the ideal shape.

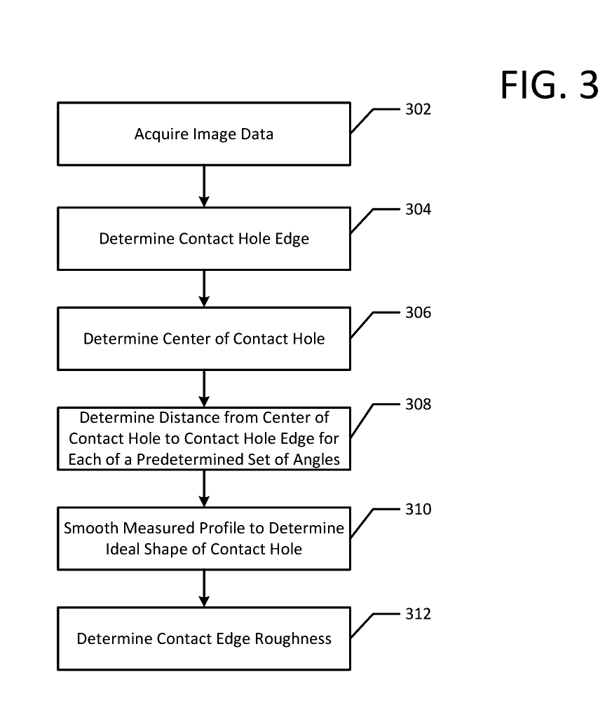

FIG. 3 provides a flowchart illustrating processes and operations that may be completed in accordance with various embodiments of the present invention. Starting at step 302, image data may be acquired corresponding to a contact hole. For example, an image capture device 80 may capture image data corresponding to a contact hole and provide at least a portion of the image data to a computing system 200. FIG. 4A shows an example rendering of at least a portion of image data corresponding to a contact hole 20 etched in wafer 10.

The acquired image data may then be analyzed to determine and/or measure the position of the edge 25 of the contact hole 20. For example, returning to FIG. 3, at step 304 the computing system 200 may analyze acquired image data to determine and/or locate the edge 25 of the contact hole. In various embodiments, a thresholding algorithm may be applied to the image data to determine the location of the contact hole edge 25, such as applied by computing system 200. FIG. 4B illustrates the results of applying a thresholding algorithm to the contact hole 20. In one embodiment, Otsu's method thresholding may be used to determine and/or locate the edge 25 of the contact hole 20. In other embodiments, various thresholding methods or other extraction methods may be used to determine and/or locate the edge 25 of the contact hole 20 from the image data. The dashed line in FIG. 4C shows the determined edge 25 of the contact hole 20, based on the thresholding of the image data illustrated in FIG. 4B. As should be understood, a variety of methods may be used to determine, extract, and/or locate the edge 25 of the contact hole 20 based on the image data.

Returning to FIG. 3, at step 306, the center 22 of the contact hole 20 is determined and/or located. For example, the computing system 200 may determine the location of the center 22 of the contact hole 20 to be the middle of the hole. At step 308, the distance between the center 22 and the edge point corresponding to a particular angle, θᵢ, may be determined. The angle θᵢ may correspond to a predefined polar coordinate system having an origin at the center 22 and/or the like. For example, the computing system 200 may determine and/or measure the distance r(θᵢ) from the center 22 of the hole 20 to the edge 25 at angle θᵢ. For example, the distance r(θᵢ) may be the radial coordinate in a polar coordinate system having an origin at the center 22 of a point located at on the edge 25 at angle θᵢ. FIG. 5A illustrates the process of measuring the distance from the center 22 to the edge 25 at a particular angle θᵢ. In various embodiments, a reference point other than the center of the contact hole may be used (e.g., the origin of the polar coordinate system may be located at reference point other than the center 22).

In various embodiments, a predetermined set of n angles may be defined, {θᵢ|i ∈ [symbol] , i≦n}, and the distance r(θᵢ) from the center 22 (or other reference point) to the point on the edge 25 at angle θᵢ may be determined and/or measured for each θᵢ. In one embodiment, {θᵢ} comprises n angles equally spaced between 0 and 2π radians, −π and π radians, −180° and 180°, 0° and 360°, and/or the like. In another embodiment, the n angles of {θᵢ} may more densely sample a particular portion of the edge 25, as may be particularly useful if a portion the ideal shape, described elsewhere herein, has a more complicated edge than the remainder of the ideal shape.

FIG. 5B shows an example hole profile 32 of a contact hole edge 25, wherein the hole profile 32 comprises all or at least some of the determined and/or measured distances r(θᵢ) from the center 22 to the edge 25 at each predetermined angle, θᵢ (e.g., {r(θᵢ)|θᵢ ∈ {θᵢ}}). Thus, for example, the computing system 200 may determine and/or measure r(θᵢ) for each θᵢ by measuring and/or determining the distance between the center 22 and the edge 25 of the contact hole 20 and define the hole profile 32 as the set of determined and/or measured r(θᵢ) (e.g., {r(θᵢ)}).

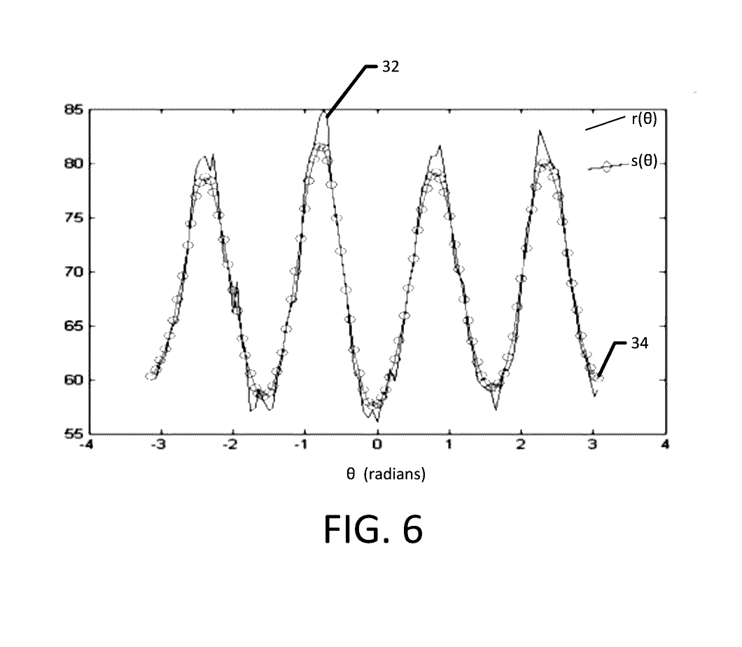

Returning to FIG. 3, at step 310, the ideal shape of the contact hole 20 is determined. For example, in some embodiments, the computing system 200 applies a smoothing technique to the hole profile 32, {r(θᵢ)}, to determine/calculate a smoothed profile 34, {s(θᵢ)}, as illustrated in FIG. 6. The smoothed profile 34, {s(θᵢ)}, may be configured to describe the ideal shape for the hole 20 (e.g., the shape the hole 20 would have if the edge 25 were smooth). For example, each point of the smoothed profile 34 (e.g., s(θᵢ)) may describe the distance from the center (or other reference point) of the ideal shape to the edge of the ideal shape at one of the predetermined angles, θᵢ. In one embodiment, the computing system 200 applies a local linear smoother to the hole profile 32, {r(θᵢ)}, to determine the smoothed profile 34, {s(θᵢ)}. In some embodiments, the selected reference point of the ideal shape aligns with the selected reference point of the contact hole 20. For example, in some embodiments, the center of the ideal shape aligns with the center of the contact hole 20. It should be understood that the scope of the present invention includes a variety of methods that may be used to determine the ideal shape of the contact hole 20 based on the hole profile 32.

Returning to FIG. 3, at step 312, the contact edge roughness (CER) is determined/calculated. For example, the CER may be based at least in part on the deviation of the hole profile 32, {r(θᵢ)}, from the ideal shape (e.g., as represented by the smoothed profile 34, {s(θᵢ)}). Thus, in some embodiments, the CER may depend on the difference between the ideal shape (e.g., as described by the smoothed profile 34) and the hole profile 32 (e.g., the CER may depend on (r(θᵢ)−s(θᵢ)) for at least one angle θᵢ). In one embodiment, the CER is determined/calculated based on the formula CER=3×

$$\sqrt{\frac{1}{n} {\sum }_{i = 1}^{n} {( r ( {θ}_{i} ) - s ( {θ}_{i} ) )}^{2}} .$$

In other embodiments, the CER may be calculated based on other formulas, as appropriate for the application.

### V. Conclusion

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for measuring the contact edge roughness of a hole, the method comprising:
acquiring image data corresponding to the hole;
based at least in part on the image data, determining a hole profile, the hole profile configured to describe a distance from a reference point of the hole to an edge of the hole for each angle of a predetermined set of angles;
determining an ideal shape for the hole based at least in part on the hole profile, wherein the ideal shape for the hole is described by a distance from a reference point of the ideal shape to an edge of the ideal shape for each angle of the predetermined set of angles; and
determining the contact edge roughness based at least in part on the hole profile and the ideal shape.

2. The method of claim 1 wherein the image data is acquired via a scanning electron microscope.

3. The method of claim 1 further comprising:
determining the edge of the hole based at least in part on the image data.

4. The method of claim 3, wherein the reference point of the hole is the center of the hole and the reference point of the ideal shape is the center of the ideal shape, the method further comprising:
determining the center of the contact hole based at least in part on the determined edge of the hole.

5. The method of claim 3 wherein the step of determining the edge of the hole comprises thresholding the image data.

6. The method of claim 1 wherein determining the ideal shape is based at least in part on applying a smoothing function to the hole profile.

7. The method of claim 6 wherein the smoothing function is a local linear smoother.

8. A system for measuring the contact edge roughness of a hole, the system comprising at least one processor and at least one memory including program code, the at least one memory and the program code configured to, with the processor, cause the system to at least:
acquire image data corresponding to the hole;
based at least in part on the image data, determine a hole profile, the hole profile configured to describe a distance from a reference point of the hole to an edge of the hole for each angle of a predetermined set of angles;
determine an ideal shape for the hole based at least in part on the hole profile, wherein the ideal shape for the contact hole is described by a distance from a reference point of the ideal shape to an edge of the ideal shape for each angle of the predetermined set of angles; and
determine the contact edge roughness based at least in part on the hole profile and the ideal shape.

9. The system of claim 8 wherein the image data is acquired via a scanning electron microscope.

10. The system of claim 8, the at least one memory and the program code further configured to, with the processor, cause the system to at least:
determine the edge of the hole based at least in part on the image data.

11. The system of claim 10, wherein the reference point of the hole is the center of the hole and the reference point of the ideal shape is the center of the ideal shape, the at least one memory and the program code further configured to, with the processor, cause the system to at least:
determine the center of the hole based at least in part on the determined edge of the hole.

12. The system of claim 10 wherein to determine the edge of the hole, the at least one memory and the program code are configured to threshold the image data.

13. The system of claim 8 wherein to determine the ideal shape the at least one memory and the program code are configured to apply a smoothing function to the hole profile.

14. The system of claim 13 wherein the smoothing function is a local linear smoother.

15. A non-transitory computer program product for measuring the contact edge roughness of a hole, the computer program product comprising at least one computer-readable storage medium having computer-readable program code portions embodied therein, the computer-readable portions comprising:
an executable portion configured to acquire image data corresponding to the hole;
an executable portion configured to, based at least in part on the image data, determine a hole profile, the hole profile configured to describe a distance from a reference point of the hole to an edge of the hole for each angle of a predetermined set of angles;
an executable portion configured to determine an ideal shape for the hole based at least in part on the hole profile, wherein the ideal shape for the hole is described by a distance from a reference point of the ideal shape to an edge of the ideal shape for each angle of the predetermined set of angles; and
an executable portion configured to determine the contact edge roughness based at least in part on the hole profile and the ideal shape.

16. The computer program product of claim 15, the computer-readable portions further comprising:
an executable portion configured to determine the edge of the hole based at least in part on the image data.

17. The computer program product of claim 16, wherein the reference point of the hole is the center of the hole and the reference point of the ideal shape is the center of the ideal shape, the computer-readable portions further comprising:
an executable portion configured to determine the center of the hole based at least in part on the determined edge of the hole.

18. The computer program product of claim 16 wherein the executable portion configured to determine the edge of the hole based at least in part on the image data is configured to threshold the image data.

19. The computer program product of claim 15 wherein the executable portion configured to determine the ideal shape for the hole based at least in part on the profile is configured to apply a smoothing function to the hole profile.

20. The computer program product of claim 19 wherein the smoothing function is a local linear smoother.
